(19) United States
(12) Patent Application Publication
(10) Pub. No.: US 2002/0118272 A1
(43) Pub. Date: Aug. 29, 2002

(54) Video conferencing system

(76) Inventor: Jeremy Bruce-Smith, Blackrock (IE)

Correspondence Address: STANDLEY & GILCREST LLP, 495 METRO PLACE SOUTH, SUITE 210, DUBLIN, OH, 43017, US

(21) Appl. No.: 09/878,359

(22) Filed: Jun. 11, 2001

(30) Foreign Application Priority Data
Feb. 23, 2001 (IE) S2001/0170

(51) Int. Cl. H04N 7/14

(52) U.S. Cl. 348/14.08

(57) ABSTRACT

A video conferencing system comprises a video codec 24 and an ISDN interface 34 for selectively sending still or video images from a locally attached camera 62 to a remote video conferencing system, and for displaying such images received from the remote system on a local monitor 26. A graphics card 16 also allows a local application program, such as a web browser, to be run and its output viewed on a second local monitor 28. In order to allow the application to be viewed also by the remote system, the output of the application program currently displayed on the second monitor can be transmitted as a still image to the remote system in the same manner as a still image from the camera.

### FIELD OF THE INVENTION

This invention relates to a video conferencing system.

### BACKGROUND OF THE INVENTION

Video conferencing systems are known in which it is possible to selectively transmit still or video images to a remote video conferencing system, and to receive such images from the remote system for display locally. It is also known for video conferencing systems to run an application program, such as a web browser, whose output is displayed locally. A video conferencing system having these features is the VuLink Video Conferencing Set-Top Box manufactured and marketed by Ivron Systems Ireland Limited. This is an integrated system having an ISDN port, a camera port, two monitor ports, speaker output(s) and microphone input(s). This system can run a browser under the control of a remote control handset and rendered on one of the monitors. However, at present it is not possible to transmit the output of the browser for viewing at the remote system.

Thus it is an object of the invention to provide a video conferencing system which is able to send images displayed by the browser (or other application) as still images to the remote system for viewing by the users of that remote system.

### DISCLOSURE OF THE INVENTION

Accordingly, the present invention provides a video conferencing system comprising:

means for receiving a still image or a video image from at least one locally attached camera;

means for selectively transmitting, as determined by a user, said still image or said video image to a remote video conferencing system;

means for receiving a still image or a video image from said remote video conferencing system and displaying same on at least one locally attached display device; and

means for running a local application program and displaying the output thereof simultaneously with the display of the received image;

the circuit further including means for transmitting, at a time determined by the user, the currently displayed output of the application program as a still image to said remote video conferencing system.

### BRIEF DESCRIPTION OF THE DRAWINGS

An embodiment of the invention will now be described, by way of example, with reference to the accompanying drawings, in which:

FIG. 1 is a block diagram of a video conferencing system according to the invention; and

FIG. 2 is a flow chart of the operation of the relevant part of the conferencing application for the transmission of the local web browser window as a still image.

### DESCRIPTION OF THE PREFERRED EMBODIMENT

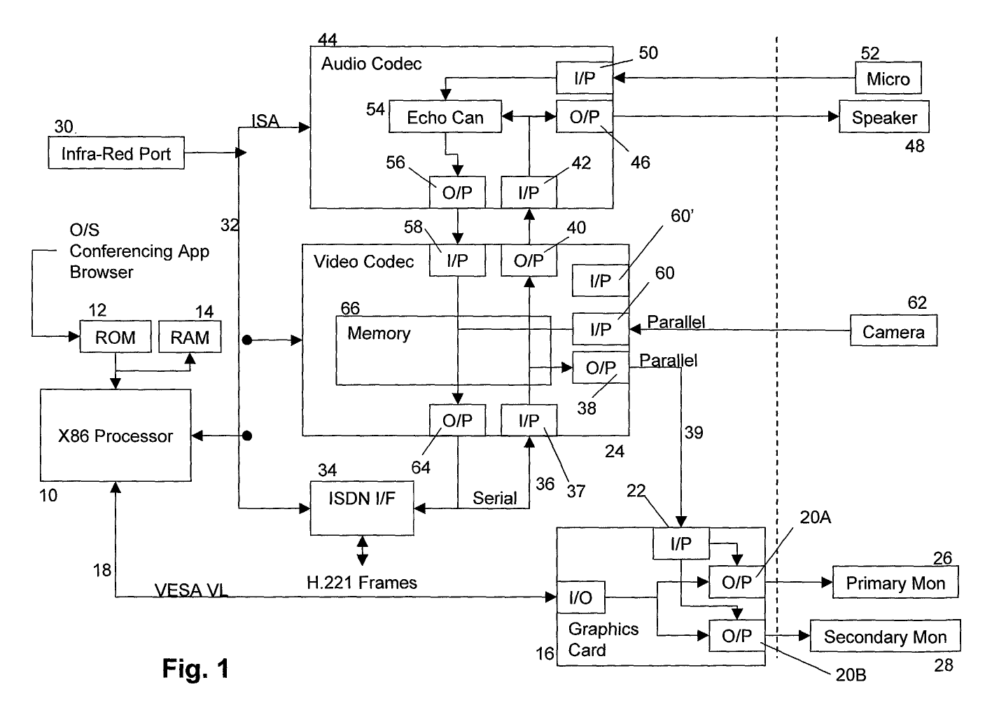

Referring first to FIG. 1, the embodiment of the invention is based upon the known, commercially available VuLink Video Conferencing Set-Top Box, referred to above, which operates according to the H.320 protocol for ISDN Video Conferencing. In FIG. 1 the set-top box comprises the components to the left of the dashed line; those to the right of the dashed line are supplied and connected by the user. The conventional aspects of the system will first be briefly described, followed by the modification according to the embodiment.

The system comprises an Intel x86 processor 10 connected via an internal bus to ROM 12 and RAM 14. The system is based on the Windows CE operating system (O/S), stored in the ROM 12. The ROM also contains a conferencing application which provides overall user control of the system, as well as a web browser and any other application programs to be run locally. The Windows CE O/S enables the ROM 12 to appear as a virtual drive and allows the processor 10 to boot up the operating system and drivers and load the conferencing application, browser and any other applications into RAM 14. Conventional developer software available from Microsoft enables the ROM 12 to be programmed.

The screen views of the browser or other running application program are rendered by the processor 10 through a VGA graphics card 16, in this case, a CyberPro 2010 from IGS, connected to the processor over a conventional VESA VL bus 18. The graphics card 16 supports two monitor outputs 20A, 20B and can be configured to display application screen views received from the bus 18 and live video received through a parallel input port 22 from a video coder/decoder (codec) 24 either in combination on a primary monitor 26 or on separate primary and secondary monitors 26, 28.

In the conventional system it is known to run the web browser (or other application) for display on the secondary monitor 28 and the conferencing application, in combination with live video, on the primary monitor 26. User interaction with either application is then carried out, using a remote control handset signalling an infrared port 30 located within the set-top box, via an on-screen menu on the monitor 26. A National Semiconductors 87109 chip is used to decode the IR and this is connected to an ISA bus 32.

The processor 10 is connected via the ISA bus 32 to an ISDN interface module 34, in this case, an ISDN BRIck (Bearer Rate Interface Chip) from Ezenia. The ISDN I/F transmits and receives H.221 frame information to and from the video codec 24 via a serial interface 36. On the input channel the video codec 24, in this case, a VCP from 8×8, splits the frame information received at input port 37 into audio and video information. Video is decoded and transmitted from a parallel output port 38 via a parallel bus 39 to the input port 22 of the graphics card 16. Audio is transmitted via an output port 40 to an input port 42 of an audio codec 44, in this case, one of a pair of DSP chips from Analog Devices.

The audio codec 44 decodes the audio data and transmits it via an output port 46 to a speaker 48. An input port 50 also receives a signal from a microphone 52 and supplies it to the second of the DSP chips acting as an echo canceller 54. This combines the speaker signal with the microphone signal to cancel the speaker signal from the microphone signal and transmits the resulting signal via an output port 56 to an audio input port 58 of the video codec 24.

The video codec 24 combines the audio signal with a still image or continuous video data received at an input port 60 from a camera 62, for example a Philips 7111, to produce H.221 frame information on an output port 64 connected to the ISDN interface chip 34.

The processor 10 is connected to both the audio and video codecs 24, 44 via the ISA bus 32 enabling the codecs to be configured and controlled at least in part by user interaction with the conferencing application.

The user can selectively request that the video codec 24 transmit either a high resolution still image or a low resolution continuous video image within the H.221 video information portion of the H.221 packet. Conventionally, this enables the codec 24, to switch from the low resolution video input 60 to a high resolution still image input 60′ connected to a still image camera (not shown), and have this information stored as an H.261 Annex D image in the portion of the video codec memory 66 allocated for still images. Once the still image has been transmitted, the video codec 24 switches back to transmitting a continuous low resolution video image from the video camera 62.

At the remote video conferencing system, a user (normally through interaction with their own conferencing application) either can set the length of time for which a received still image is displayed before reverting back to continuous video on the same monitor, or the user can allocate a portion of the monitor display area for display of received still images in a PIP (picture-in-picture) format, until they are refreshed, while leaving the remainder of the monitor display area for continuous video. (Nonetheless, this continuous video stream is interrupted while the still image is being received.)

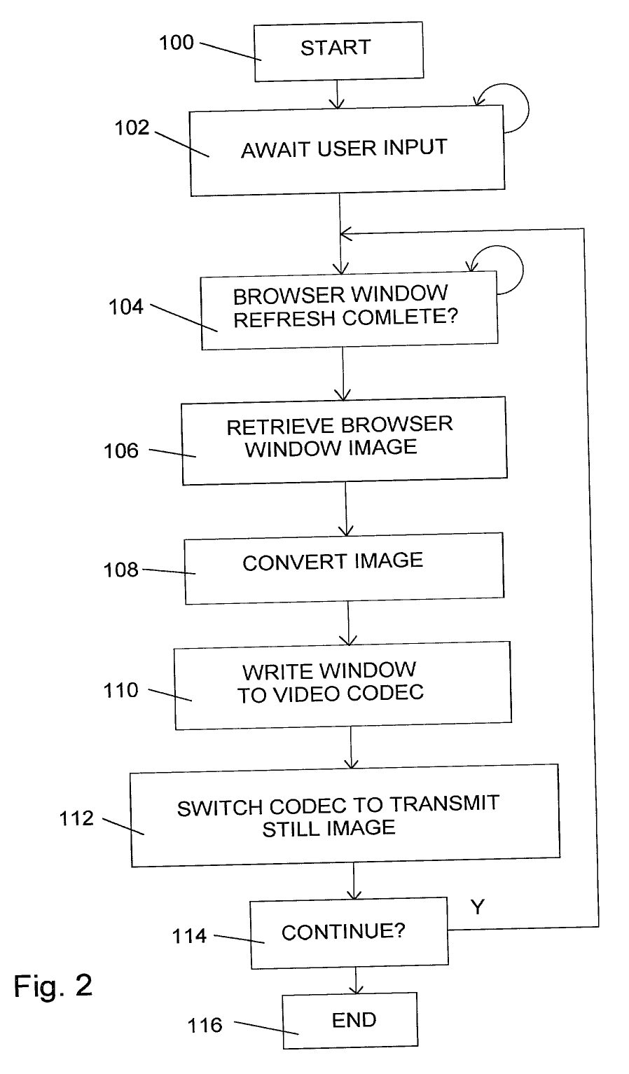

As mentioned above, the system as thus far described is a commercially available system. However, using the conventional system, users at one or both ends can run the web browser (or other application) and have this rendered on, for example, the secondary monitor. However, one user will not be able to see the browser display being seen by the other. Thus, according to the embodiment of the invention, the conferencing application in the ROM 12 includes an extra routine, FIG. 2, to allow the user to transmit the current browser (or other application) window as a high resolution still image for viewing at the remote system.

When the routine is invoked (step 100) it waits for a user input (step 102) indicating that the current browser window, as displayed for example on the secondary monitor 28, is to be transmitted to the remote system. The user input may be, for example, the selection of a menu item on the primary monitor 26. Next, the routine ensures that the browser window is not currently undergoing refresh (step 104) following which the processor is instructed to retrieve the current browser window from the graphics card 16 (step 106), convert it from a bitmap image to a YUV 4CIF Annex D format image (step 108), and write it (step 110) to the portion of the video codec memory 66 allocated for still images (i.e. the same portion which would otherwise store still images from the camera 62).

Now the routine instructs the video codec to switch the video codec 24 to transmit the stored browser image as a high resolution still image exactly as it would for a still image received from the camera 62 (step 112). Next, the routine determines if the user wants to transmit further browser windows as they are refreshed (step 114). This is an option at step 102. If so, the routine reverts to step 104. If no further browser windows are to be transmitted, as determined by user input, for example via the menu on the monitor 26, the video codec 24 reverts to low resolution video mode and the routine ends (step 116).

If the remote receiving system is not compliant with the invention, then it will display the still browser image as it would any other still image. On the other hand, if the receiving system is compliant and supports two monitor outputs, then it can display the still image on the secondary monitor for a pre-determined period. This will overwrite any application view already rendered on the secondary monitor for a pre-determined period, before reverting back to the previous display. Alternatively, the still image can be displayed, as with other still images, in a picture-in-picture format on the primary monitor, so enabling the receiving user not only to view their own browser application view on the secondary monitor, but also that of the other user on the primary monitor.

Although the invention has been primarily described in terms of an H.320 ISDN video conferencing system it is clearly applicable to other protocols, such as H.323 LAN systems. Also, the invention is not limited to the transmission of browser images, but may be used for the transmission of any application window.

The invention is not limited to the embodiment described herein which may be modified or varied without departing from the scope of the invention.

1. A video conferencing system comprising:
means for receiving a still image or a video image from at least one locally attached camera;
means for selectively transmitting, as determined by a user, said still image or said video image to a remote video conferencing system;
means for receiving a still image or a video image from said remote video conferencing system and displaying same on at least one locally attached display device; and
means for running a local application program and displaying the output thereof simultaneously with the display of the received image;
the circuit further including means for transmitting, at a time determined by the user, the currently displayed output of the application program as a still image to said remote video conferencing system.

2. A system as claimed in claim 1, wherein the output of the application program is displayed on a second locally attached display device.

3. A system as claimed in claim 1, wherein the application program is a web browser.

4. A system as claimed in claim 3, wherein the means for transmitting the currently displayed output of the application program automatically transmits a new still image each time the browser display is updated.

5. A system as claimed in claim 1, wherein the still image is in H.261 Annex D format.

6. A system as claimed in claim 1, wherein the still image is at a higher resolution than the video image.

7. A system as claimed in claim 6, wherein the transmitting means includes a video coder/decoder capable of processing both high resolution still images and low resolution video images, the currently displayed output of the application program selected for transmission being read into the coder/decoder and transmitted thereby in the same manner as a still image from the at least one camera.
